(19) United States
(12) Patent Application Publication
(10) Pub. No.: US 2017/0312745 A1
(43) Pub. Date: Nov. 2, 2017

(54) LIGHTING SOLUTION FOR A CONTAINMENT CHAMBER

(71) Applicant: Getinge La Calhene, Vendome (FR)

(72) Inventors: Nidhal Guelmami, Lussault sur Loire (FR); Pascal Goulay, Crucheray (FR)

(21) Appl. No.: 15/522,079

(22) PCT Filed: Oct. 28, 2015
(86) PCT No.: PCT/EP2015/074965

§ 371 Date: Apr. 26, 2017

(30) Foreign Application Priority Data
Oct. 28, 2014 (FR) 1460348

(51) Int. Cl. B01L 1/02; B25J 21/02

(52) U.S. Cl. CPC B01L 1/02; B25J 21/02; B01L 2300/043; B01L 2300/046

(57) ABSTRACT

A hatch that can be connected to a compartment such as the workstation or transfer airlock of a containment chamber, the hatch (17) comprising a wall (21), a seal (22) and a lighting device (23), the seal (22) allowing the passage of at least part of the radiation of the lighting device (23), the lighting device being arranged so as to omit the light in a direction at least partly opposite to the wall (21) and through the seal (22). The invention also relates to a containment chamber provided with such a hatch (17).

### TECHNICAL FIELD

The invention relates to insulators usually used in pharmaceutical production or laboratories and in hospital pharmacy. These sealed and confined chambers allow a mutual staff/product protection towards chemical and microbiological contaminations without compromising the environment.

### STATE OF PRIOR ART

One exemplary insulator 10 is illustrated in FIG. 1. Such an insulator 10 generally includes the following different sub-assemblies: a workstation 11 of the glove box type, a transfer or airlock system 12, a control system 13, a system 14 for allowing handling (for example with gloves), ventilation/filtration means 15, a steriliser 16.

Some insulators 10 include a hatch allowing access inside the workstation 11 for loading and washing phases. The sealing at the hatch between inside the workstation 11 and outside can then be made by means of a static seal.

The invention aims at providing an improved hatch.

### DISCLOSURE OF THE INVENTION

Thus, the invention relates to a hatch that can be connected to a compartment of a containment chamber, the compartment being possibly for example an access airlock or a workstation, the hatch including a wall, a seal and a lighting device, the seal allowing at least part of the radiation of the lighting device to pass, the latter being provided so as to emit light along a determined lighting direction and through the seal.

The light from the lighting device is preferably emitted along at least one direction opposite to a direction, or to the direction, which goes from the lighting device, to the wall.

The light from the lighting device is emitted to at least part of the compartment or the containment chamber or to at least part of the internal volume (or of a working zone and/or the compartment) of a containment chamber or to the workstation or to inside the workstation and/or to an airlock or to inside an access airlock.

Being made of a material letting at least part of the radiation pass, the seal combines a sealing function and a function allowing the light emitted by the lighting system to pass.

The seal also enables the lighting device to be protected from the insulator atmosphere, in particular during decontamination cycles.

Such a seal also enables a system for protecting an independent lighting system to be dispensed with.

Further, during decontamination cycles, some decontamination product (or liquid) can remain in the interstices between a seal and the adjacent walls. This can require some efforts for removing the decontamination product.

The absence of a lighting system in the workstation itself thus enables the number of seals about which an amount of product is likely to remain and to be limited consequently to save time during decontamination cycles.

Further, a hatch such as described above makes it possible to avoid glare of a user of the containment chamber.

Such a hatch also enables the beam distribution in the compartment to be improved.

Furthermore, the emission angle of the lighting device can be chosen so as to only light a particular zone of the compartment that the hatch fills in a closed position. Advantageously, the seal can be structured to include a tinted portion and/or a portion masking and/or limiting the radiation of the lighting device in a particular zone of the compartment, for example an external mask or provided in the seal bulk. The seal can further be structured to diffuse more particularly the radiation of the lighting device in a particular zone of the compartment.

Advantageously, the lighting device is provided in a thickness of the hatch included between an internal surface of the wall and a leg of the hinge opposite to the wall.

The hatch can further include hinge means, including a pressing zone pressing against said wall and a leg opposite to this wall, the thickness of the hatch being included between said internal surface of the wall and a surface parallel to said internal surface and passing through said leg.

The hatch can further include a frame including at least one planar part on or against which at least the wall is attached.

The seal can be attached at least partly to the frame.

The frame can include an L-section, a first part of which is parallel to the wall, and a second part of which extends perpendicular to the wall.

The hatch can further include support means, attached on or against the frame.

The support means can include a first branch which is substantially parallel to said planar part of the frame and a second branch substantially perpendicular to the first branch.

The seal can include a first pressing part, in a closed position of the hatch, and a second pressing part pressing against said wall.

The lighting device can be provided between said wall and a surface of the seal which faces said wall. The lighting device can further be partly or totally embedded in the seal.

The lighting device can include at least one light emitting diode.

The lighting device can also emit at at least two different wavelengths. That can be advantageous to notify an operator different states of the hatch, for example a defect state or an operational state when the hatch is fluid sealingly closed.

The seal can be made of a material which diffuses at least part of the radiation emitted by the lighting device. Such a material enables the lighting offered to be improved, for example in the entire workstation.

Alternatively or in addition, the seal can include diffusing particles and/or have at least one granular surface and/or one surface having a relief, configured to diffuse light passing therethrough.

Such structures of materials are also very advantageous for radiation distribution for example in the entire workstation.

The seal can include snap-on elements, the hatch further including a load-bearing structure in which the snap-on elements are housed. Such a seal structure is particularly simple and cheap to implement.

The hatch can further include a wall provided with means allowing handling.

The invention further relates to a containment chamber including for example an airlock or a workstation, and including a hatch as described above.

The invention also relates to an airlock, for example a containment chamber, including a hatch as described above.

Such a chamber thus has at least the above listed advantages of reducing the overall space of the lighting elements, reducing the duration of the decontamination cycles, reducing or removing the user glare and improving the beam distribution in the compartment.

The chamber can include a workstation which includes for example a working plane in its internal volume, the lighting device being provided so as to emit light towards said internal volume, for example towards said working plane when the hatch is in a closed position, the luminous flux reaching said internal volume, for example said working plane, when the lighting device emits a radiation that can have a value lower than or equal to 1 500 lux, for example lower than or equal to 1 000 lux.

### BRIEF DESCRIPTION OF THE DRAWINGS

Embodiments of the invention will now be described by way of non-limiting examples, referring to the appended drawings, in which:

FIG. 1 is a perspective view of an existing insulator, as described in the preamble,

FIG. 2 is a cross-section view of the lighting system according to the invention,

FIG. 3 is an alternative of the lighting system represented in FIG. 2.

### DETAILED DISCLOSURE OF PARTICULAR EMBODIMENTS

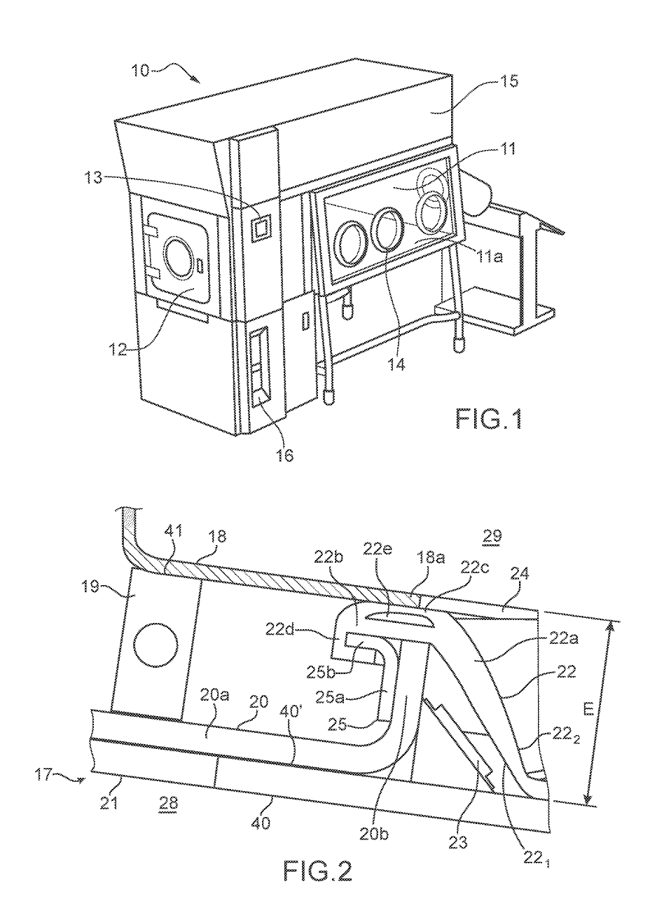

FIG. 2 illustrates a hatch 17 according to the invention, for a containment chamber, for example of the type of the insulator 10 described above in connection with FIG. 1.

The insulator 10 here includes a hatch 17 and an internal liner 18.

The liner 18 delimits a compartment such as the workstation 11 or the airlock 12.

An aperture 24 is provided through the inner liner 18 on a face of the compartment 11 or 12. The aperture 24 is here of a rectangular shape but can have a different shape, for example of a square.

The hatch 17 includes a wall 21, a seal 22 and a lighting device 23, the latter being provided so as to emit light along a determined lighting direction and through the seal 22. When the hatch 17 is in a closed position, it fluid sealingly fills the aperture 24, thereby the seal 22 at least partly presses against a portion of the external surface, facing outside the insulator, of the liner 18. Further, when the lighting device 23 emits radiation in this closed position, this radiation is directed at least partly to the internal volume 29 of a compartment 11 or 12 or the airlock 12.

The seal is here delimited between 2 surfaces 22₁, 22₂, the first one facing the wall 21 and the other one, when the hatch is in the closed position, facing the internal volume 29. The lighting device 23 is mounted in an internal volume of the hatch 17, which is fluid sealed, delimited between the wall 21 and the surface 22₁ of the seal 22.

Means 20, 25 enable the seal to be held in the internal volume of the hatch 17 and/or against the wall 21.

Thus, in the embodiment illustrated in FIG. 2, the device 23 includes a load-bearing structure 20 or a frame and also possibly a support 25 attached to said frame 20. The frame 20 can form a mounting support, both for the wall 21 and the seal 22. The support 25 enables the mechanical latch of the seal in the hatch 17 to be enhanced.

The hatch 17 can be mounted on the liner 18 through a hinge 19. In a particular embodiment, the hinge 19 connects the liner 18 to the frame 20. The hinge 19 can for example be mounted on the upper mount or on one of the side mounts of the frame 20 such that the hatch 17 can open upwardly or sideways.

Here, the wall 21 is a transparent window pane or includes at least one transparent part. This wall 21 can be provided or not with means 14 allowing handling, for example of the type allowing gloves to be introduced (FIG. 1). A hatch 17 the wall 21 of which is free of means 14 can form a hatch for accessing a compartment such as the airlock 12, or inside the airlock 12, or even a simple glazed door for accessing a compartment such as the workstation 11.

In the example represented in FIG. 2, the frame 20 has, in the plane of the Fig., an L-section a first branch 20a of which can be sandwiched between the hinge 19 and the wall 21, in parallel to the general orientation of the wall 21, and the other branch 20b of which extends from inside the first branch 20a, towards the rim 18a of the liner 18 when the hatch 17 is in the closing position, that is transverse or perpendicular to the wall 21 and to the branch 20a.

According to one embodiment, a support 25, also with an L-section, can be attached to the branch 20b of the frame by a first branch 25a which is substantially parallel to this branch 20b. A second branch 25b of the support 25 here extends transverse or perpendicular to the branch 20b of the frame, outwardly, that is opposite to the aperture 24.

In the embodiment illustrated in FIG. 2, the seal 22 includes four sections 22a to 22d:
two centre sections 22b, 22c one of which 22b is flat and the other 22c is bent for pressing against the external surface of the liner 18, thus defining a sealing zone; both these sections can delimit between them an inner space 22e the volume of which will vary as a function of the opening or closing state of the hatch, the closing causing a compression of the seal when it presses against the surface of the liner 18;
an elongate section 22a which here extends slopping towards the wall 21, from a first end common to the sections 22b and 22c; one end of this elongate section 22a presses against the internal surface of the wall 21;
a rim 22d, one end of which is connected to the second end of the flat centre section 22b, opposite to the first end; this rim is folded in front of the flat section 22b or so as to define a portion parallel to this same flat section 22b.

Preferably, the seal 22 is mounted to the rest of the hatch 17 such that:
the flat section 22b of the seal and its rim 22d wrap around three sides of the branch 25b, the branch 20b further coming in contact with the section 22b of the seal; the seal 22 is thus held on the frame 20;
the elongate section 22a is in fluid sealed contact with the wall 21.

When the hatch 17 is closed, the wall 21 fills the aperture 24, the seal 22 ensuring fluid sealing on the edges thereof. In particular, the bent section 22c of the seal 22 is thereby in fluid sealed contact against the rim 18a.

By virtue of the fixedly mounted seal 22, the hatch 17 thus ensures a fluid sealing between an internal volume 29 of the insulator 10 and outside 28.

In the embodiment represented here, the lighting device 23 is mounted in an internal volume of the hatch 17, which is fluid sealed, delimited by the cross beam 20b of the frame 20, the wall 21 and the surface 22₁ of the seal 22 which is opposite to the surface 22₂ directed to or facing the internal volume 29.

Alternatively, in an alternative not represented, the seal 22 is moulded about the lighting device 23, or in other words, the lighting device 23 is embedded, wholly or partly, in the bulk of the seal 22; or even the seal 22 is formed about all or part of the lighting device 23.

The lighting device 23 is provided so as to emit light along a lighting direction, through the seal 22, such that the radiation can be propagated along at least one direction opposite to that directed, from the lighting device 23, towards the wall 21.

Generally, the lighting device 23 can include one or more light emitting diodes (LED).

Advantageously, the device 23 can emit at least two wavelengths, for example according to different lighting colours, which can be interesting to signal a defect of the insulator 10 with one of these colours.

The lighting device 23 is provided to offer a luminous lighting, for example up to 1 500 lux, of a working plane 11a internal to the compartment 11 or 12 (FIG. 1).

As is understood from the explanations above, generally, the lighting device 23 of a device according to the invention is mounted in the thickness E of the hatch, that is in an internal volume of the hatch 17, preferably included between an inner surface 40′ of the wall 21 and a plane defining a zone pressing against a surface (here the outer surface of the wall 18); this plane can be the same as a plane defined by an end surface 41 of the hinge 19 opposite to the end surface of the latter located on the side of, or facing, the wall 21.

The seal 22 is made at least partly of a transparent or translucent material or of a translucent mixture of materials. It allows the radiation to pass at at least one emission wavelength of the lighting device 23. Preferably, it also ensures a diffuser function for this same radiation. To that end, the material of the seal 22 can, for example, include diffusing particles. The seal 22 can further have one or more granular surface(s) or one or more surfaces with reliefs.

In a non-limiting way, the seal 22 can be made of silicon or EPDM.

The shapes of the different elements described above, for example the frame 20, and/or the seal 22 and/or the support means 25 are not limiting.

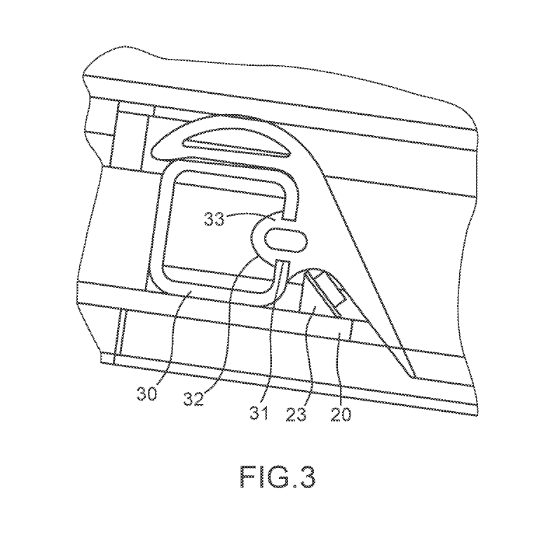

For example, in an alternative illustrated in FIG. 3, the frame 20 is substantially planar. Against this frame is attached, alternatively to the support 25, a square cross-section support 30. Ports 31 are provided on a face of this support 30 which faces the lighting device 23. Projections 32 can be formed on the seal 22. They include an annular rim 33 forming a snap-on or detent member cooperating with the perimeter of the ports 31.

Further alternatively or in a complementary way, detent pins which are not illustrated can be included in the material of the seal 22. Such pins are for example made of a more rigid material than the material of the seal 22. Each pin can include a head, for example embedded in the material of the seal 22 upon manufacturing. Receiving ports such as the ports 31 in which the pins can be accommodated are thereby provided on or through the frame 20 and/or the support means 25.

A method of treating a product of the insulator 10 can implement the following steps of:
closing the hatch;
introducing, for example using means 14, the product to be treated; this step can optionally be made before the preceding one;
lighting the working zone using the lighting means 23 provided in the hatch;
treating the product to be treated;
stopping lighting and/or opening the hatch to recover the product.

The invention can find application in pharmaceutical production, hospital pharmacy and/or in a research and development unit (such as in a laboratory).

The invention can also find application in other fields such as in agro-food industry or in nuclear industry.

What is claimed is:

1-19. (canceled)

20. A hatch that can be connected to a compartment of a containment chamber, the hatch including a wall, a seal and a lighting device, the seal allowing at least part of the radiation of the lighting device to pass, the latter being provided so as to emit light along at least one direction, opposite to that which is directed from said lighting device to the wall, and through the seal.

21. The hatch according to claim 20, the lighting device being provided in a thickness of the hatch included between an internal surface of the wall and a surface defining a pressing zone of the seal.

22. The hatch according to claim 21, further including a hinge, including a pressing zone pressing against said wall and a leg opposite to this wall, the thickness of the hatch being included between said internal surface of the wall and a surface parallel to said internal surface and passing through said leg.

23. The hatch according to claim 20, further including a frame including at least one planar part on or against which at least the wall is attached.

24. The hatch according to claim 23, the seal being attached at least partly to the frame.

25. The hatch according to claim 23, the frame including an L-section, a first part of which is parallel to the wall, and a second part of which extends perpendicular to the wall.

26. The hatch according to claim 23, further including a support, attached on or against the frame.

27. The hatch according to claim 26, the support including a first branch which is substantially parallel to said planar part of the frame and a second branch substantially perpendicular to the first branch.

28. The hatch according to claim 20, the seal including a first pressing part, in a closed position of the hatch, and a second pressing part pressing against said wall.

29. The hatch according to claim 20, the lighting device being provided:
between said wall and a surface of the seal which faces said wall;
or in the seal.

30. The hatch according to claim 20, the lighting device including at least one light emitting diode.

31. The hatch according to claim 20, the lighting device emitting at at least two different wavelengths.

32. The hatch according to claim 20, the seal being made of a material which diffuses at least part of the radiation emitted by the lighting device.

33. The hatch according to claim 32, the seal including diffusing particles and/or having at least one granular surface.

34. The hatch according to claim 20, the seal including snap-on elements, the hatch further including a load-bearing structure in which the snap-on elements are housed.

35. The hatch according to claim 20, further including a wall provided with means allowing handling.

36. A containment chamber including a hatch according to claim 20.

37. The containment chamber according to claim 36, including a compartment including a working plane in an internal volume, the lighting device being provided so as to emit light towards the working plane when the hatch is in a closed position.

38. The containment chamber according to claim 37, the luminous flux on the working plane having, when the lighting device emits a radiation, a value lower than or equal to 1000 lux.
